(19) United States
(12) Patent Application Publication
(10) Pub. No.: US 2005/0234764 A1
(43) Pub. Date: Oct. 20, 2005

(54) Methods and apparatus for material requirements estimation and inventory management

(75) Inventors: John Bailey King III, New Freedom, PA (US); Francis Xavier Zane JR., New Providence, NJ (US)

Correspondence Address: PRIEST & GOLDSTEIN PLLC, 5015 SOUTHPARK DRIVE, SUITE 230, DURHAM, NC, 27713-7736, US

(73) Assignee: Lucent Technologies, Inc., Murray Hill, NJ (US)

(21) Appl. No.: 10/827,637

(22) Filed: Apr. 19, 2004

(51) Int. Cl. G06F 17/60

(52) U.S. Cl. 705/10

(57) ABSTRACT

Systems and techniques for determining an amount of reserve material required to meet demand. A period of uncertainty during which varying demand for a product or component must be considered may be computed by taking into account various time intervals relating to the time required to obtain a component of a product and to and incorporate it into a product that is ready for delivery. The number of reserve products or components required may be computed by taking into account the demand for the component. The demand may suitably be expressed in terms of a forecast demand per time unit and a variance factor that provides a desired assurance that demand can be met in the face of deviations from the forecast demand. The forecast demand and variance factor are used to compute a reserve needed in light of the period of uncertainty for the product or component being considered.

### FIELD OF THE INVENTION

The present invention relates generally to improvements in material requirements planning and inventory management. More particularly, the invention relates to systems and techniques for analyzing anticipated demand for materials and material availability so as to identify and maintain a reserve that will provide a prescribed probability that sufficient materials will be on hand to meet demand.

### BACKGROUND OF THE INVENTION

Material management and inventory control is vital to any manufacturing operation. A typical manufacturing operation involves the assembly of a number of different items into a finished product. In order to meet customer requirements, a number of factors need to be taken into account. These include the customer demand, the time required to receive components, the time required to assemble components into a finished product and deliver the product to the customer, and the reserve of components kept on hand. In order to meet customer demand, it is necessary either to have components on hand, to be able to receive components and assemble a product within the time prescribed by customers or both.

Customer demand, the time required to receive components and the time required to assemble a product and deliver the product to the customer can all be estimated. The time required to receive components and the time required to assemble and deliver a product can be estimated with a relatively high degree of certainty. If customer demand could also be estimated with a high degree of certainty, it would be easy to determine the correct reserve to keep on hand. However, customer demand is often highly variable. A manufacturing operation frequently seeks to sell to a large number of customers, and factors affecting each customer, as well as overall market conditions, may cause wide variations in each customer's need for a product. Any material inventory should therefore be sufficient to allow for higher customer demand, in order to insure that demand can be met.

Unfortunately, maintaining inventory is relatively expensive, requiring investment of capital to pay for the inventory itself, and further requiring the dedication of space to storing the inventory and personnel to securing and managing the inventory. It is therefore highly undesirable to maintain levels of inventory beyond those actually required.

Prior art techniques exist for estimating reserve requirements. These techniques often involve computation of mean demand and standard deviations from the mean demand. Such computations are often highly sensitive to changes in demand and require frequent updates in light of newly received demand information, at a cost of considerable complexity and computational effort.

There exists, therefore, a need for systems and techniques to determine the level of reserve material required to provide a specified level of assurance that customer demand requirements will be able to be met, without requiring excessive levels of reserves beyond those necessary to provide the specified level of assurance, and that offer computational simplicity and the computation and use of parameters that are relatively robust against changes in demand information.

### SUMMARY OF THE INVENTION

A system according to one aspect of the invention receives information relating to material availability and demand, and uses the information to determine the amount of reserve material required. The reserve materials required depend on a period of uncertainty, related to the lead time required to receive materials and assemble and deliver a product, compared with the time allowed by a customer to fill an order.

The required reserve may suitably be determined by taking into account the demand for the component. The demand may suitably be expressed in terms of a forecast demand per predefined time unit, and a variance factor. The forecast demand is an expected average or normal volume, and may be expressed as a constant. The variance factor allows for deviations from the forecast demand, and is determined by statistical analysis.

The variance factor is determined by first setting a desired level of assurance, such as 95%, that the level of materials in the reserve will be sufficient to meet demand, and then performing statistical analysis using demand information in order to compute the variance factor. The forecast demand and the variance factor are used to determine the reserve required in light of the period of uncertainty.

Many products produced by an organization can be considered in groups, so that the present invention provides systems and techniques for defining variance factors that can be applied to all products in a group. For each product in a possible grouping, a variance factor can be computed for a plurality of time intervals that may be equal to a period of uncertainty for a product within the grouping, with a variance factor value being computed for each time interval from one time unit to the maximum period of uncertainty for any product within the grouping. Each variance factor value is examined to determine whether it will produce a sufficient reserve for each product in the grouping, and the smallest variance factor value that produces a sufficient reserve for a sufficient number of products is chosen. In addition, the distribution of variance factor values may be examined to identify desirable product groupings, with a variance factor value being computed for each grouping so as to provide a satisfactory reserve level for that grouping. In addition, the distribution of reserve levels and variance factor values may be examined in order to derive a formula that will allow the computation of an appropriate variance factor value for differing conditions, such as differing periods of uncertainty.

The variance factor for each product grouping is relatively stable, and once a variance factor is computed for a product grouping, it is relatively reliable for that grouping, even if peak demand levels vary somewhat over time. Required reserve levels for each product grouping can be updated using variance factors, without a comprehensive analysis of the historical data each time a reserve level is to be computed. Because of the relative stability of the variance factor, analysis of historical data can be performed relatively infrequently.

A more complete understanding of the present invention, as well as further features and advantages of the invention, will be apparent from the following Detailed Description and the accompanying drawings.

### BRIEF DESCRIPTION OF THE DRAWINGS

FIG. 1 illustrates a system for performing reserve requirements analysis according to an aspect of the present invention;

FIG. 2 illustrates a process of variance factor computation for a single time window, according to an aspect of the present invention;

FIG. 3 illustrates a process of variance factor computation for a series of time windows, according to an aspect of the present invention;

FIG. 4 illustrates a process of computation and selection of a variance factor applicable to multiple products, according to an aspect of the present invention;

FIG. 5 illustrates a reserve analysis module according to an aspect of the present invention; and

FIG. 6 illustrates a process for performing reserve requirements analysis according to an aspect of the present invention.

### DETAILED DESCRIPTION

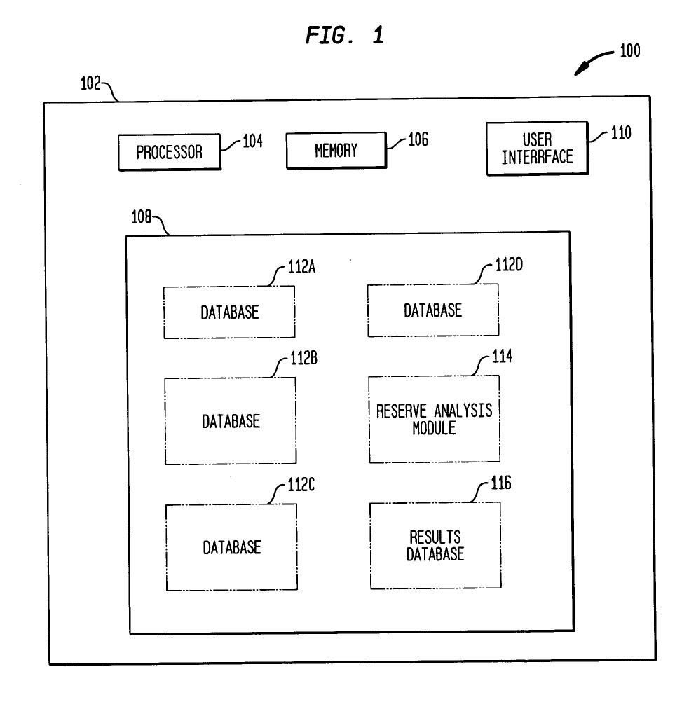

FIG. 1 illustrates a system 100 for performing reserve requirements analysis according to an aspect of the present invention. The system 100 includes a server 102 including a processor 104, memory 106 and long term storage 108, as well as a user interface 110. The server 102 maintains various databases such as the databases 112A-112C, suitably hosted on the long term storage 108. The database 112A includes historical requirements for each product produced by an operation. Suitably, the database 112A includes an entry for each day in a desired historical period, with the entry indicating the volume of product required on that day. The database 112B suitably serves as a translation table for products to components. The database 112B includes an entry for each product produced by the manufacturing operation, with each entry listing each component, and the quantity of the component, used in the product. The database 112C includes an entry for each component used in the operation, with each entry listing each product in which the item is used and the quantity of the component used by the product. The database 112D includes time interval information for each component, including provisioning interval, replenishment lead time, replenishment frequency, as well as assembly and test time for each product in which the item may appear.

The database 112C also includes time interval information related to each item, with the time interval information including replenishment lead time, that is, the time interval between ordering of an item and the time the item is received, the replenishment frequency and the time required to assemble and test a product including the item and to make it available for delivery, as well as the provisioning interval, which is the time allowed by a customer for filling an order.

The server includes a reserve analysis module 114, suitably implemented as software stored on the long term storage 108 and executed by the processor 104. The reserve analysis module 114 receives instructions from the user interface 110. For example, the user may specify a product, with reserve requirements to be computed for material items serving as components of that product, and may specify the desired level of assurance that demand for the product can be satisfied.

The reserve analysis module 114 examines the database 112B to identify the items of material for which computations are to be made, and examines the database 112 to obtain time interval information for each item. The reserve analysis module 114 then computes a reserve requirement for each item, expressed in terms of days of stock, that is, the number of days of supply that is required.

The reserve requirement needed depends on the period of uncertainty. The period of uncertainty is the difference between the time required to assemble and deliver a product and the time allowed to fill an order. For example, if the time required to assemble and deliver a product is 5 days and the time allowed between the time an order is placed and the time delivery is required is 3 days, the period of uncertainty is 2 days. Therefore, sufficient reserve stock should be maintained to fill two days' worth of demand. If the time allowed for delivery is greater than or equal to that required to assemble and deliver the product, there is no period of uncertainty and no reserve need be maintained, because the assembly process can be started when an order is placed and the product will still be delivered on time.

The period of uncertainty is given by the following sum:

the Replenishment Lead Time (RLT) plus the Replenishment Frequency (RF) plus the Assembly and Test Time (ATT) minus the Provisioning Interval (PI) is equal to the period of uncertainty (PU) In equation form, RLT+FT+ATT−PI=PU. The term, “period of uncertainty” is used because that is the period for which the uncertainty of demand has an effect.

The period of uncertainty is reliably provided by the above computation, and if the volume required per time period could be known with certainty, it would be easy to determine the required quantity of an item by simply multiplying the number of time periods in the period of uncertainty by the requirement per time period. However, the required volume is likely to vary, and may vary substantially. Therefore, the reserve analysis module 114 analyzes historical data stored in the database 112A, in order to obtain a base value for expected requirements, and a variance from the base value. The base value may suitably be an estimated expected volume, for example an average volume determined simply by averaging volume values taken from the database 112A. The variance factor indicates the excess over the base volume that needs to be maintained in order to meet requirements when demand levels are unexpectedly high, and is expressed here as a multiplier to be applied to the base volume. The variance is determined by statistical analysis of the demand values in the database 112A.

After computing the period of uncertainty, the reserve analysis module 114 then examines the database 112A to determine a base volume for the product, suitably using a technique that will yield a reasonable value for an expected requirement. Examples of such techniques are computing the mean requirement or the median requirement. To illustrate the advantage that may be gained by using the median requirement, suppose that the mean requirement of a product, such as computers, is 45 computers, but the value of the mean is elevated due to an unusually high demand occurring during a single time period. In such a case, it may be considered more appropriate to use the median demand over the historical period in order to compensate for this anomaly. To take another exemplary case, a truncated mean can be used as the base volume. Use of a truncated mean can be particularly beneficial when demand data is noisy.

The reserve analysis module 114 then computes a variance factor to be applied to the base demand, in order to provide an assurance that the reserve quantity maintained will provide a predetermined level of assurance, in this case 95%, that the actual demand to be experienced can be met. The variance factor is used to set a reserve level sufficient that even though demand levels will sometimes exceed the forecast demand, the demand level will be met in 95% of all cases. The same approach can be used for other measurements of assurance. For example, the required assurance may be an assurance that 95% of item demand will be satisfied, and the variance factor can computed accordingly.

In order to determine the variance factor to be set, the reserve analysis module 114 examines the database 112A to determine the demand for a product over the historical period. If desired, the demand for each component can also be determined using the information retrieved from the database 112C. The reserve analysis module 114 performs statistical analysis, using the demand information, to determine a variance factor that will set the reserve at a level that will provide the prescribed level of assurance.

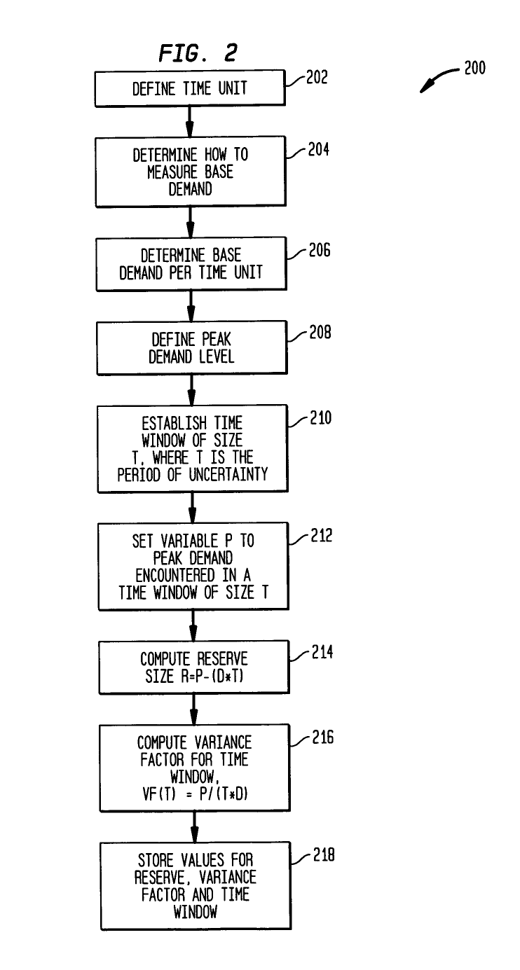

FIG. 2 illustrates a process 200 for determining a reserve size and variance factor for various periods of uncertainty. The process 200 may suitably be used by the reserve analysis module 114 of FIG. 1.

First, at step 202, a time unit is defined, which will be the time unit by which the demand level and the period of uncertainty are measured. For example, if the time unit is a day, the demand level used will be the daily demand and the period of uncertainty will be measured in days.

At step 204, a determination is made as to how to measure base demand, for example mean long term demand, the median demand over the preceding month, or some other desired measurement criterion.

At step 206, the base demand D per time unit is determined. For example, if the time unit is one day and the base daily demand is 30, the variable D is set to a value of 30.

At step 208, the peak demand level is defined. The peak demand level is the demand level at or below which assurance is to be provided. For example, if the peak demand level is that demand is to be met in 95% of all time periods of interest, assurance is to be provided that only 5% of time windows will show a demand level above the peak demand level. A time window is a defined time interval ranging between 1 time unit to the total number of time units in the period of uncertainty.

At step 210, a time window of size T, where T is the period of uncertainty, is established.

At step 212, the variable P is set to a value equal to the peak demand encountered in a time window of size T. This is done by examining the database 112A, determining the demand in each time window of size T reflected in the database 112A and setting the value of the variable P to a value equal to the peak demand level defined at step 206. For example, if the database 112A includes information for 20 1-day periods and the size of the time window T is one day, the demand might be as follows:
Day 1-10; Day 2-15; Day 3-12; Day 4-18; Day 5-60; Day 6-75; Day 7-42;
Day 8-19; Day 9-25; Day 10-32; Day 11-18; Day 12-41; Day 13-39; Day 14-27;
Day 15-23; Day 16-37; Day 17-43; Day 18-22; Day 19-58; Day 20-61.

In this case, the value of P would be 61, because the demand level does not exceed 61 in 95% of cases. It will be noted that the value of P is likely to be relatively stable. In the typical case, data will be stored for many more than 20 time periods. If the value of P is the maximum demand encountered in 95% of all time periods, then once a value for P is established, it will not change unless the demand exceeds the value of P in more than 5% of all time periods or falls below P in more than 95% of all time periods. These conditions are unlikely to occur even if demand varies over a fairly large range, because deviations will need to be relatively numerous. In particular, an established value of P is highly likely to be sufficient to reflect demand encountered in the specified number of cases, such as 95%. Even if demand exceeds the value of P by a substantial margin, such increases in demand can be treated as outliers and the previously established value of P will be sufficient because it will reflect demand encountered in 95% of cases, or whatever the specified proportion of cases may be.

At step 214, the reserve size R is computed as follows: R=P−(T*D). This expression computes the difference between the peak demand and the base demand for the time window. It will be seen that the base demand for the time window is the base demand per time unit, multiplied by the number of time units in the time window. It will also be noted that as the size of the time window increases, the peak demand for the time window comes closer to the base demand for the time window. The reason for this is that as a time window increases in size, it includes more observations, and these observations tend to balance one another out. For example, if demand encountered within ten 1-day time window is 5 units, 7 units, 2 units, 8 units, 9 units, 3 units, 4 units, 6 units, 1 unit and 5 units, the mean demand is 5 units and the peak differs from the mean by 4 units, or 80% of the mean. If the same demand data is considered in terms of two 5-day intervals, the demand encountered during the first interval is 31 units and the demand encountered during the second interval is 19 units. The mean demand over the two time windows is 25 units. The peak demand differs from the mean demand by 6 units, or 24% of the mean.

At step 216, the variance factor for the time window T is computed as follows: VF(T)=P/(T*D). The variance factor will tend to be smaller for large time windows than for small time windows, and will also tend to be relatively stable because, as noted above, the value of P will not change unless a relatively sustained variation in demand is experienced.

At step 218, the reserve size R and the variance factor VF(T) are stored, in association with the time window size T for which they were computed. Storage may suitably be in the database 116 hosted on the server 100 of FIG. 1.

To take an example of the analysis performed by the system 100, consider a server computer consisting of a housing, a motherboard, four memory cards, a video card and 2 hard drives. The time intervals for the various components are shown in the following exemplary table.

| Component | RLT | PI | RF | ATT | PU |
|---|---|---|---|---|---|
| Housing | 10 | 4 | 8 | 1 | 15 |
| Motherboard | 8 | 3 | 5 | 1 | 11 |
| Memory card | 4 | 2 | 1 | 1 | 4 |
| Video card | 7 | 3 | 4 | 1 | 9 |
| Hard drive | 3 | 1 | 2 | 1 | 5 |

The variance factor is computed by examining the historical demand for computers. The time window T used is 15 days, because the longest period of uncertainty for a component is 15 days, the period of uncertainty for the housing. Suppose that the base daily demand D for computers is 30, and the highest demand in 95% of the 15 day intervals examined, that is, the peak demand P, is 1350. In that case, the reserve requirement would be R=P—(D*T), that is, 1350−(30*15), or 900. The variance factor would be VF(T)=P/(D*T), that is, 1350(15*30), or 3. Thus, the variance factor takes into account both the reserve quantity needed to provide for variations in demand as well as the items to be ordered to supply the base demand.

Once the variance factor has been established, the forecast demand is multiplied by the reserve requirement in order to determine the number of computers needed for one day's reserve. If the variance factor is 3, the number of computers needed for one day's reserve is 90. Each computer requires 1 housing, 1 motherboard, 4 memory cards, 1 video card and 2 hard drives, so that one day's reserve for each of these components is expressed as follows:
Housing—90
Motherboard—90
Memory card—360
Video card—90
Hard drive—180

These totals are then multiplied by the number of days in the period of uncertainty for each component, to yield the following results:

| Component | Period of Uncertainty | Total Units |
|---|---|---|
| Housing | 15 | 1350 |
| Motherboard | 11 | 990 |
| Memory card | 4 | 1440 |
| Video card | 9 | 810 |
| Hard drive | 5 | 900 |

The calculation of reserve quantities discussed above has been presented in terms of required units. Alternatively, a similar calculation can be performed in order to present the requirements in terms of days of stock, that is, the number of days' worth of inventory required. This calculation is performed using the variance factor, the number of components per item and the period of uncertainty. The requirement in terms of days of stock can then be used to compute the number of units required by multiplying the days of stock requirement by the base demand D. The base demand D often varies more frequently than the other variables used in the calculation of demand, and so performing the calculation in terms of days of stock allows for the generation of a relatively stable days of stock requirement that can be updated relatively infrequently, with more frequent updating being performed for the base demand value D.

In many if not most cases, demand patterns for a product remain consistent over time. Even if forecast demand increases or decreases, the pattern of deviation from the forecast demand can be expected to remain consistent. It is convenient, therefore, to derive a formula that yields the variance factor. Examination of the database 112A and processing of the demand values over multiple assurance levels and using standard curve fitting techniques to derive a formula will typically yield a formula that provides accurate results and can be applied to yield a variance factor for whatever level of assurance is desired.

In many cases, demand behavior will be relatively consistent for all products produced by an organization, and in other cases, demand behavior will be consistent across multiple product lines. Therefore, in determining applicable variance factors to be used in determining reserve requirements, it is possible to analyze overall demand behavior. Typically, a system such as the system 100 will have access to numerous databases similar to the database 112A, one for each product for which reserve requirements are to be computed. Such databases are also useful for other purposes. It is a simple matter, therefore, for the reserve analysis module 114 to examine each database storing demand information for a product and examine the variance properties of the information stored in the database. The demand variance characteristics are likely to be very similar across all products, or alternatively groupings of products sharing similar demand variance characteristics are likely to be present. The reserve analysis module suitably computes formulas for as many variance factors as may be needed, and associates the formula for each variance factor with the products whose demand characteristics are best described by that formula.

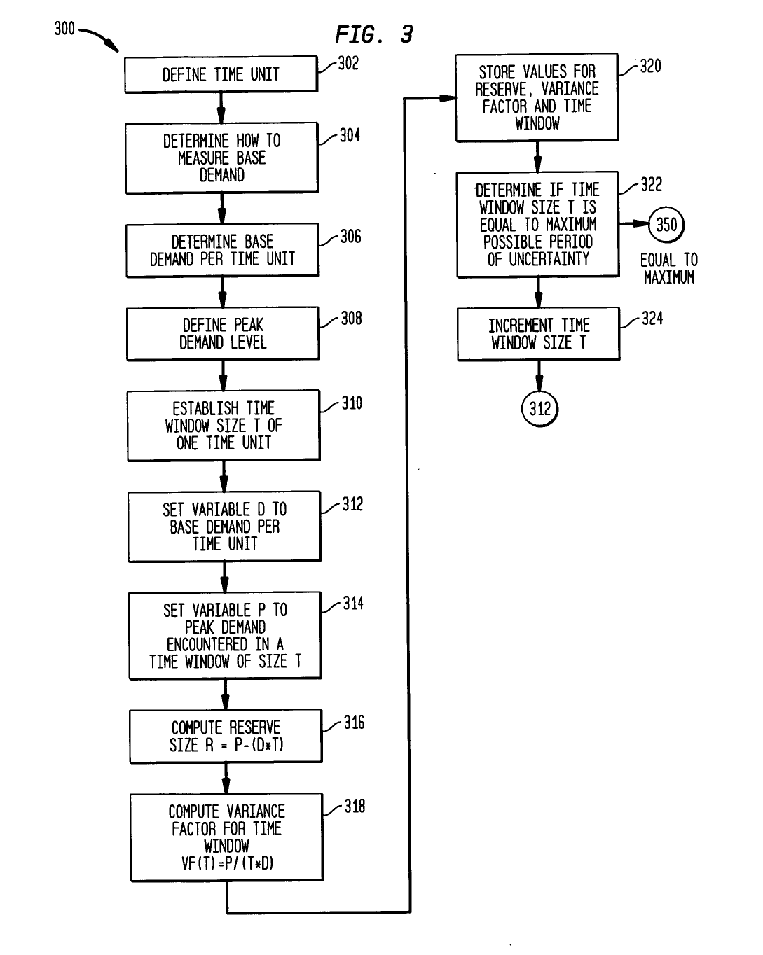

FIG. 3 illustrates the steps of a process 300 for computing variance factor values for a sequence of possible time windows, with the time windows ranging from one time unit to the maximum period of uncertainty presented by any product to be included in a proposed grouping. The process is similar to the process 200 of FIG. 2, but is expanded to compute and store values for a range of time windows from 1 time unit to maximum possible period of uncertainty.

First, at step 302, a time unit is defined, which will be the time unit by which the demand level and the period of uncertainty are measured. For example, if the time unit is a day, the demand level used will be the daily demand and the period of uncertainty will be measured in days.

At step 304, a determination is made as to how to measure base demand, for example mean long term demand, the median demand over the preceding month, or some other desired measurement criterion.

At step 306, the base demand D per time unit is determined. At step 308, the peak demand level is defined. The peak demand level is the demand level at or below which assurance is to be provided. For example, if the peak demand level is 95%, assurance is to be provided that only 5% of time windows will show a demand level above the peak demand level. A time window is a defined time interval ranging from 1 time unit to the total number of time units in the maximum period of uncertainty presented by any product in a proposed grouping.

At step 310, a time window size T of one time unit is established.

The following sequence of steps comprises a loop that is repeated X times, where X is the number of time units in the maximum period of uncertainty presented. For example, if the time unit is one day and the maximum period of uncertainty is 21 days, the following sequence of steps is repeated 21 times.

At step 312, the variable D is set to a value equal to the base demand per time unit. For example, if the time unit is one day and the base daily demand is 30, the variable D is set to a value of 30.

At step 314, the variable P is set to a value equal to the peak demand encountered in a time window of size T. This is done by examining the database 112A, determining the demand in each time window of size T reflected in the database 112A and setting the value of the variable P to a value equal to the peak demand level defined at step 306.

At step 316, the reserve size R is computed as follows: R=P−(T*D). This expression computes the difference between the peak demand and the base demand for the time window. It will be seen that the base demand for the time window is the base demand per time unit, multiplied by the number of time units in the time window.

At step 318, the variance factor for the time window T is computed as follows: VF(T)=P/(T*D).

At step 320, the reserve size R and the variance factor VF(T) are stored, in association with the window size for which they were computed. Storage may suitably be in the database 116 hosted on the server 100 of FIG. 1.

At step 322, the time window size T is examined to determine if it is equal to the maximum period of uncertainty. If the time window size T is not equal to the maximum period of uncertainty, the process proceeds to step 324; otherwise, the process ends at step 350. At step 324, the time window size T is incremented by one time unit. The process then returns to step 312.

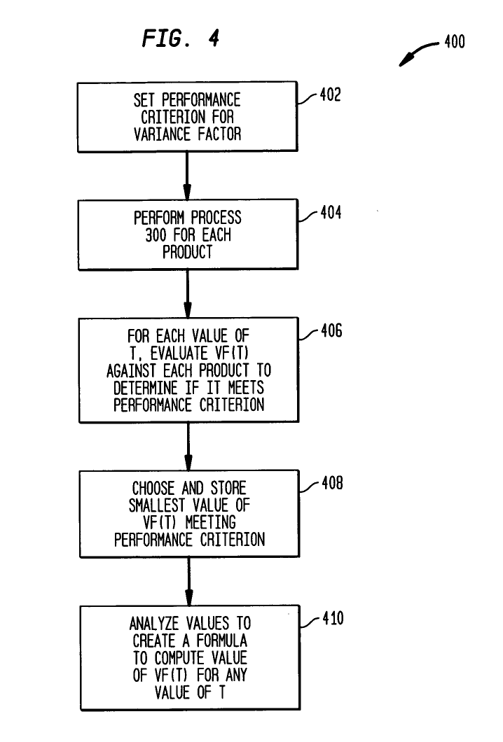

FIG. 4 illustrates the steps of a process 400 for computing variance factor values to be used for a grouping of products, for example the products in a product line or the products produced by an organization. At step 402, a criterion is set for performance for the variance factor. For example, the variance factor may be required to satisfy demand at a specified level of assurance, for example, 95%, for a specified minimum number of products in the grouping. Alternatively, the variance factor may be required to satisfy the demand for a minimum value of products.

At step 404, the process 300 is performed for each product, yielding a sequence of values VF(T) for each product, where T ranges from 1 to the maximum possible period of uncertainty. At step 406, for each value of T, each value of VF(T) is evaluated against each product to determine if it meets the performance criterion for the product. At step 408, for each value of T, the smallest value of VF(T) meeting the criterion specified in step 402 is chosen and stored.

At step 410, the values chosen are analyzed to generate a formula that can be used to produce a value of VF(T) for any value of T. For example, a formula family such as VF(T)=aT^{b} may be chosen, with curve fitting techniques being used to choose values of a and b.

Depending on the distribution of the variance factor values, it may be desirable to employ multiple variance factors for multiple groupings of products. In performing the process 400 above, if it is determined that more than one substantial mode exists for the variance factors, that is, if the reserve requirement for a significant number of products, such as 50% of the total, is met by one variance factor value and the reserve requirement for a significant number of different products, such as the other 50% of the total, is met by another variance factor value, the products may be divided into two groups and the processes 300 and 400 repeated for each group.

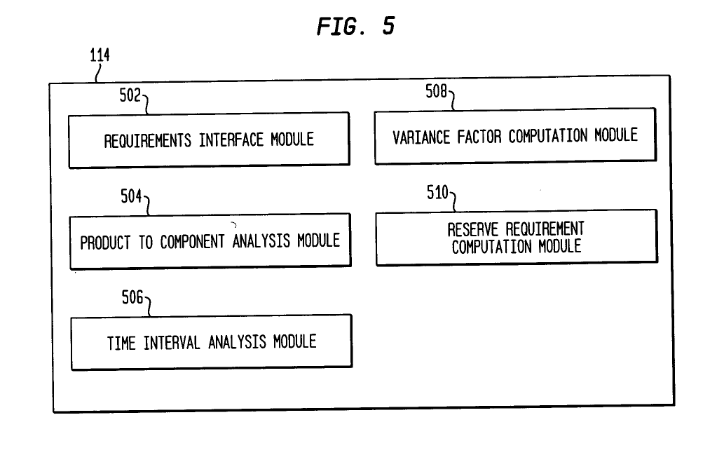

FIG. 5 illustrates additional details of an embodiment of a suitable reserve analysis module 114 of FIG. 1. The reserve analysis module comprises a requirements interface module 502, a product to component analysis module 504, a time interval analysis module 506, a variance factor computation module 208 and a reserve requirement computation module 510. The requirements interface module 502 receives information about the product for which analysis is to be performed and the level of assurance that is to be provided that requirements will be met. The product to component analysis module 504 examines the database 112C to determine the components needed for the product. The time interval analysis module 506 examines the lead time requirements for each component to compute the period of uncertainty applicable to each component. The variance factor computation module 508 computes the variance factor, for example, by applying a formula that has been previously generated or by gathering statistical information using a database such as the database 112A and processing the information. The reserve requirement computation module 510 multiplies the variance factor by the forecast demand, and then multiplies the total by the period of uncertainty applicable to each component, in order to compute the actual reserve requirement for each component.

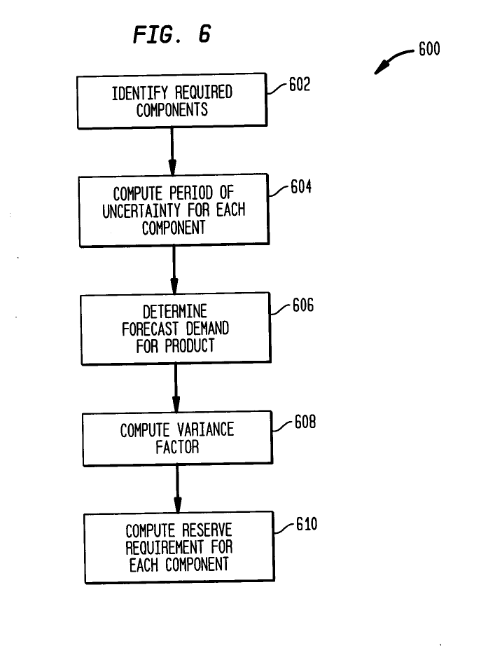

FIG. 6 illustrates a process 600 of reserve requirement computation according to an aspect of the present invention. At step 602, the components required for a product of interest are identified. At step 604, the period of uncertainty for each component is computed, by taking into account lead and assembly times versus the time allowed for filling an order. At step 606, the base demand per time unit for the product is determined. At step 608, a variance factor is computed to allow for deviations from the base demand. The variance factor is chosen to provide a specified level of assurance that the reserve will be sufficient to meet the demand, and may be computed using a predetermined formula derived from examining demand for the particular product under consideration, a product line, or demand variations experienced by an organization employing the method 600. At step 610, the reserve requirement for each component is computed by using the variance factor, the forecast demand and the period of uncertainty applicable to each component.

While the present invention is disclosed in the context of a presently preferred embodiment, it will be recognized that a wide variety of implementations may be employed by persons of ordinary skill in the art consistent with the above discussion and the claims which follow below.

1. A system for determining reserve requirements required to meet customer demand, comprising:
one or more databases for storing time interval information relating to time required to receive components for product assembly and to deliver the product to a customer, to store component information relating to identity and number of components required in a product and to store historical information relating to demand for products; and
a reserve analysis module for analyzing the component information to identify the number of each component required in a product, for analyzing the time interval information to compute a period of uncertainty for the product and for each component used in the product, the period of uncertainty reflecting a difference between the time required to assemble and deliver a product and the time allowed for delivering the product, for analyzing the historical information to determine a forecast demand and a variance factor indicating deviations from the demand and to use the period of uncertainty, the forecast demand and the variance factor to determine the number of units of each component needed as a reserve to meet anticipated demand.

2. The system of claim 1, wherein the reserve analysis module is further operative to receive an assurance requirement indicating a required level of assurance that the reserve will be sufficient to meet a level of customer demand actually encountered and to compute a variance factor such that the assurance requirement is met.

3. The system of claim 2, wherein the reserve analysis module is operative to determine a level of demand encountered in each of a series of intervals and to set the variance factor at a level so as to satisfy the demand represented by the assurance level.

4. The system of claim 3, wherein the variance factor is computed by establishing a time unit to be employed, determining a base demand D for a product, the base demand D being the expected demand encountered in a single time unit, establishing a time window size of T time units equal to the period of uncertainty for the product, to successively analyze time windows equal to T, to identify the total demand encountered in each time window and to identify a peak demand P represented by the highest demand occurring in the proportion of time windows represented by the assurance level, to set a reserve requirement R given by the expression R=P−(D*T) and to set a variance factor for a time window size T given by the expression VF(T)=P/(D*T).

5. The system of claim 4, wherein the reserve analysis module computes a period of uncertainty for each component to be used in a product, computes a base demand for each component and computes a reserve requirement for each component using the variance factor for the product, the based demand for the component and the period of uncertainty for the component.

6. The system of claim 5, wherein the reserve analysis module is further operative to compute a sequence of variance factors for a product, with a variance factor computed for each time window that may constitute a period of uncertainty for the product, from a time window of one time unit to a time window of the maximum possible period of uncertainty for the product.

7. The system of claim 6, wherein the reserve analysis module chooses a variance factor applicable to a grouping of products by computing a series of variance factors for each product in the grouping and selecting the lowest variance factor meeting the required level of assurance for the products.

8. The system of claim 7, wherein the reserve analysis module is operative to generate a formula for computing a variance factor given a specified time window size T.

9. A method of reserve requirements analysis, comprising the steps of:
identifying components for a product of interest;
computing a period of uncertainty for the product;
computing a period of uncertainty for each component used in the product;
determining a forecast demand for the product;
analyzing historical demand for the product so as to compute a variance factor needed to provide a specified level of assurance that reserves will be sufficient to meet demand that is to be encountered; and
using the values for the periods of uncertainty, the forecast demand and the variance factor to compute the reserve requirements needed to meet demand for the product.

10. The method of claim 9, wherein the step of computing the variance factor includes establishing a time unit to be employed, determining a base demand D for a product, the base demand D being the expected demand encountered in a single time unit, establishing a time window size of T time units equal to the period of uncertainty for the product, to successively analyze time windows equal to T, to identify the total demand encountered in each time window and to identify a peak demand P represented by the highest demand occurring in the proportion of time windows represented by the assurance level, to set a reserve requirement R given by the expression R=P−(D*T) and to set a variance factor for a time window size T given by the expression VF(T)=P/(D*T).

11. The method of claim 10, further comprising a step of computing a sequence of variance factors for a product, with a variance factor computed for each time window that may constitute a period of uncertainty for the product, from a time window of one time unit to a time window of the maximum possible period of uncertainty for the product.

12. The method of claim 11, further comprising choosing a variance factor applicable to a grouping of products by computing a series of variance factors for each product in the grouping and selecting the lowest variance factor meeting the required level of assurance for the products.

13. The method of claim 11, further comprising generating a formula for computing a variance factor given a specified time window size T.
